(19) United States
(12) Patent Application Publication
(10) Pub. No.: US 2006/0274443 A1
(43) Pub. Date: Dec. 7, 2006

(54) Exterior rear view vehicle mirror with reversible housing

(76) Inventors: Werner Lang, Ergersheim (DE); Albrecht Popp, Weihenzell (DE); Richard Reimchen, Ansbach (DE)

Correspondence Address: MCNAIR LAW FIRM, P.A., P.O. BOX 10827, GREENVILLE, SC, 29603-0827, US

(21) Appl. No.: 11/445,897

(22) Filed: Jun. 2, 2006

(30) Foreign Application Priority Data
Jun. 3, 2005 (DE) 102005025614.7

(51) Int. Cl. G02B 7/182

(52) U.S. Cl. 359/879; 359/872

(57) ABSTRACT

An external mirror for a vehicle is disclosed which includes a housing (1) which can be affixed to the vehicle, a mirror pane (2) and an adjustment member (3) onto which the mirror pane (2) is secured in a reference position. The mirror pane is rotatable in reference to said reference position, whereby the adjustment member (3) in at least a first and second mounting position can be affixed to the housing (1)

### BACKGROUND OF THE INVENTION

The present invention concerns an adjustable exterior vehicle mirror, particularly such a mirror which can be adjusted in a driver or passenger position.

Vehicles, in particular commercial vehicles, are today, universally equipped with a left and a right exterior mirror, or in the case of a left side operated vehicle, a “driver” and “passenger” side mirror. This assures the widest possible view for the driver over the area at the rear of the vehicle. In the case of a right side operated vehicle then, in reverse order, the left mirror becomes the passenger mirror and the right mirror serves as the driver mirror. In the following, for the sake of clarity, essentially only a left side operated vehicle will be disclosed in detail. It being understood, of course, the aspects of the invention apply in the same manner to a right side operated vehicle.

To mount external vehicle mirrors, it is known that a mirror housing must be affixed to a vehicle. A mirror pane, carried by the housing, must rotate in regard to a known reference or zero point. This rotation may be accomplished by either manual or electrical power in order to accommodate the driver's angle of sight and to adapt to the respective height of various drivers. Advantageously, the construction of the housing, which is mounted to the vehicle by either rigid or pivotal supports, resists considerable wind loadings, while the mirror pane can be adjusted precisely within the housing by a small force.

Because of the asymmetrical position of the driver when driving on the left (or right) side of the vehicle, adjustments differ for the driver and the passenger side mirrors. For example, the reference position for the driver mirror, in relation to the direction of travel, is considerably more angled than is the reference position for the passenger mirror. FIG. 1 illustrates an example of a vehicle 100 with driver and passenger side exterior mirrors 110, 120. The driver mirror 110 is shown, in FIG. 1, at its reference position, disposed at an angle α with the direction of travel, while passenger mirror 120 is set at a smaller angle β<α in order to assure for a driver 130, an ideal angle of sight.

In the state of the technology, and because of the different reference positions of the mirror pane in its respective housing, the left and the right housings have differed in construction from one another. For this reason, up to the present time, no uniform housing was available, which, by a simple reversal, could be uniformly installed as a left and/or a right housing. Disadvantageously, housings of different construction for left and right exterior mirrors needed to be designed, manufactured and inventoried.

U.S. Pat. No. 6,692,131 B1 proposes to furnish on a carrier plate, a wedge shaped adapter onto which the mirror pane can be mounted in an angular reference position by means of an adjustment member. The wedge shaped adapter possesses an angle δ=(β−α)/2. If the remainder of the carrier plate is rotated in mounting, mirror-symmetrically at the angle ε to the direction of travel and on this carrier plate, the interposed adapter be turned 180° about its vertical axis, then the result emerges, as is shown in FIG. 1 of the U.S. Pat. No. 6,692,131 B1, that the reference positions ε+δ=α or ε−δ=β. In this way, by means of uniform carrier plates and adapters, and by an interchanging of mounted positions, the different reference positions for a left and a right exterior mirror can be provided. A disadvantage in this arrangement is that separate adaptors must be provided and fastened onto the carrier plate. This increases not only the material costs and the mounting expenses, but also creates an added connection point, which, for example, can be subject to vibrations.

Accordingly, an object of the present invention is to provide an improved vehicle mirror for interchangeable use as a driver side or passenger side exterior mirror.

Another object of the invention is to provide a vehicle mirror having a reversible, interchangeable mount where the mounting costs and incidences of vibration are reduced.

### SUMMARY OF THE INVENTION

The above objectives are accomplished according to the present invention by providing an exterior vehicle mirror housing attached to the vehicle, an adjustment member interchangeably affixed to the housing, and a mirror pane carried by the adjustment member. The mirror pane can be set in one of two reference positions, and can be rotated in relation to this reference position and the housing. This adjustment member provides for a first and second affixed reference position and can be interchangeably affixed to the housing, so that the different reference positions are easily available in relation to the housing and the vehicle.

Because of the direct connection between the adjustment member and the housing, a separate intermediate adapter required by the prior art is not needed. This saves material costs and reduces the outlay for mounting. In accord with the invention, only the adjustment member need be provided. The elimination of an additional adapter reduces not only the weight, but avoids an additional connection point and thereby a weak structural location, which otherwise can cause or enhance vibrations.

Likewise, it is possible, by means of the two above stated mounting positions, different reference positions for the left and right exterior mirrors can be realized, so that, advantageously, the entire range of the adjustment member is made available for a fine adjustment of the angle of sight. Advantageously, this adjustment range can, on this account, be relatively small, since already because of the different reference positions, and the positioning of the left/right mirror is done by the driver.

Surprisingly, experience has shown, that in spite of the higher fabrication expense due to integral structural methods without the interposed adapter, and the greater material costs due to an unused mounting adjustment at the housing and the adjustment member, the invented exterior mirror is more economical in cost than the formerly known method of mounting.

Advantageously, the mirror pane, attached in the housing on the vehicle, when not rotated relative to the first reference position, makes a first angle with the direction of travel. With the adjustment member in the second reference position the mirror pane makes a second angle with the direction of travel wherein the first angle is greater than the second angle. An exterior mirror with the adjustment member mounted in a first reference position corresponds, in this example, to a driver side mirror. Similarly, an exterior mirror with an adjustment member mounted in the second mounting position corresponds, in this example, to a passenger side mirror.

Advantageously, the housing can have an integral mirror holder and a cover wherein the mirror holder part of the housing can be mounted to the vehicle by a supporting arm, and the adjustment member and/or the cover attached to the mirror holder. The cover can, in this arrangement, be releasably fastened to the holder or otherwise be made integral therewith. The former provides a heavy and stable support and a light, simple, exchangeable outer contour, the latter being of advantageous and compact manufacture.

Rotation of the mirror pane relative to the reference position can be manual, especially by means of a control linkage, or can be motor driven, especially by means of an electric motor, controllable from inside the vehicle.

Preferably, the adjustment member can be interchangeably affixed to the housing in the first or second reference position and screwed thereto in the selected position. Likewise, both parts can be affixed together and be releasable, perhaps secured with an adhesive material. An advantageous connection includes one or more snap connections, which snap together by the insertion of the adjustment member into the housing. Particularly favored is an arrangement wherein the connections in both fixed reference positions are identically formed, so that the adjustment member or the housing need have only a single connection possibility.

An advantageous connection possibility between the adjustment member and the housing includes a shape-fit or interlock fit. In this case, the housing can have at least one recess for the shape-fit acceptance of the adjustment member in the first and second reference position. Contrary to this, it is also possible, that the adjustment member itself can be provided with a recess, which, in the first or the second reference position complementarily accepts an appropriate part of the housing.

### DESCRIPTION OF THE DRAWINGS

The invention will be more readily understood from a reading of the following specification and by reference to the accompanying drawings forming a part thereof, wherein an example of the invention is shown and wherein:

FIG. 1 is a schematic view illustrating relative positions of a driver mirror and a passenger mirror in a left side operated vehicle;

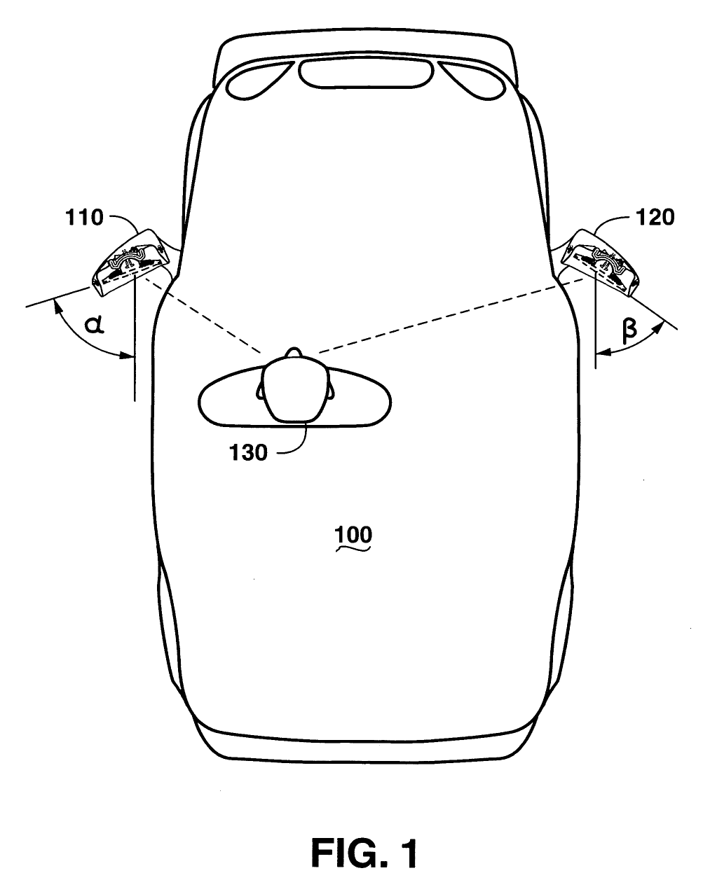

FIG. 2 is a sectional plan view illustrating an exterior vehicle mirror in accord with a first embodiment of the present invention with an adjustment member fixed in a first reference position;

FIG. 3 is a sectional plan view illustrating an exterior vehicle mirror in accord with FIG. 2 with the adjustment member rotated 180° and fixed in a second reference position; and

FIG. 4 is a sectional plan view illustrating an exterior vehicle mirror according to the invention mounted as a driver and passenger side mirror with the adjustment of FIG. 3.

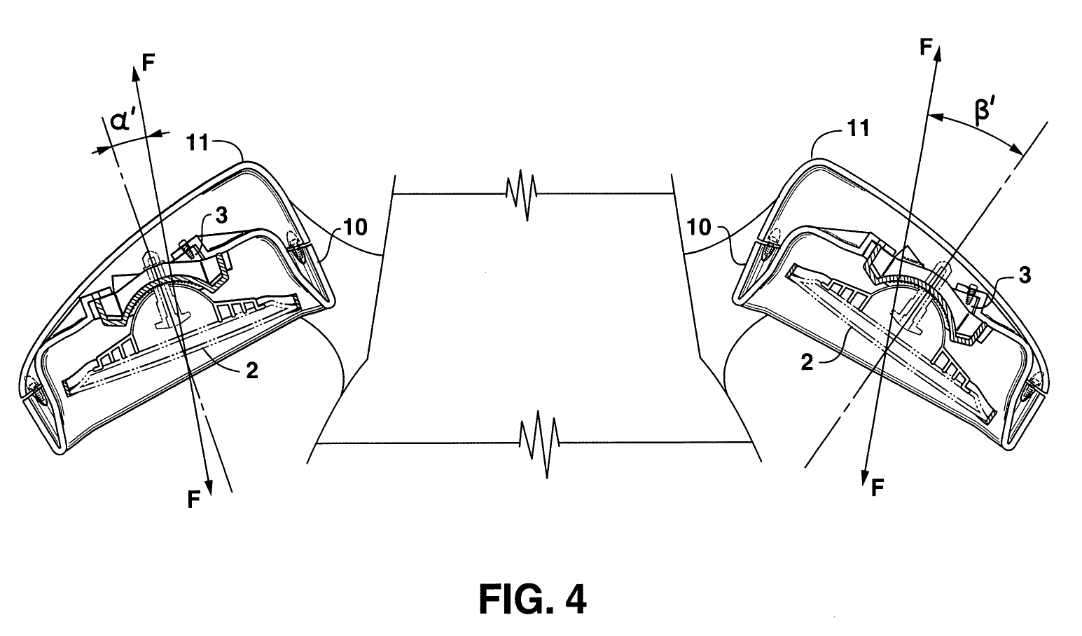

### DESCRIPTION OF A PREFERRED EMBODIMENT

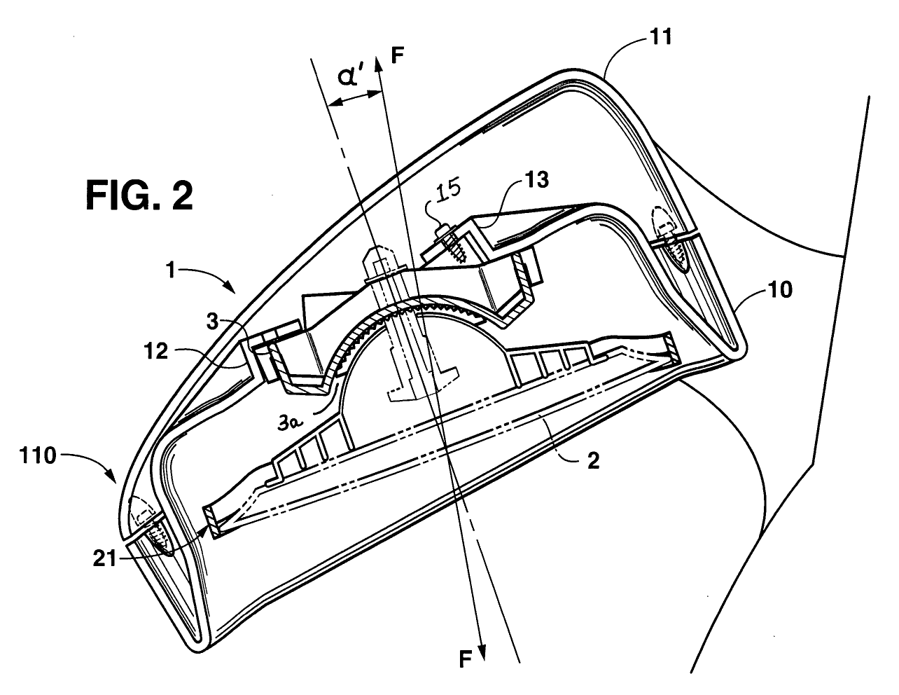

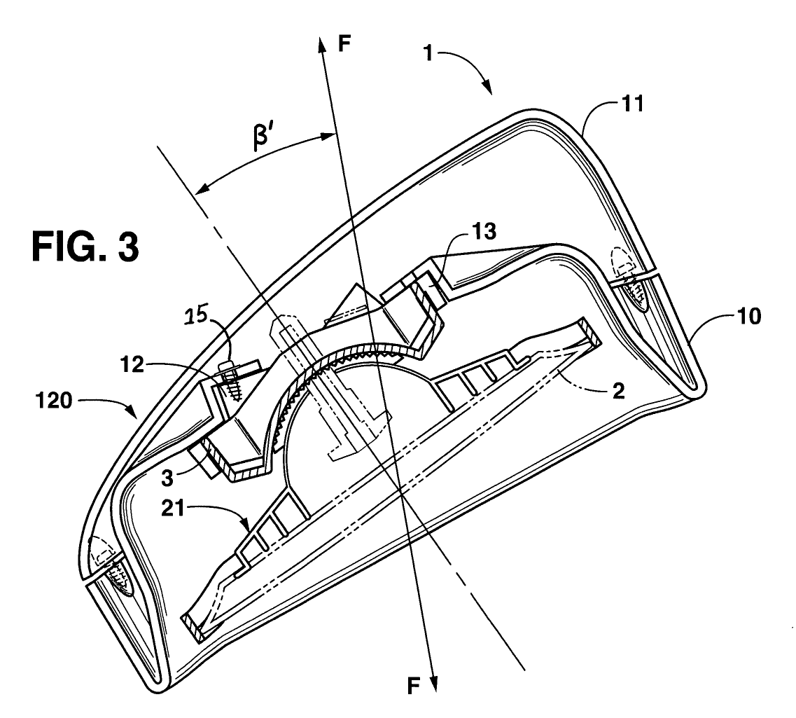

Referring now in more detail to the drawings, the invention will now be described in more detail. FIGS. 2 and 3 show an exterior vehicle mirror assembly, designated generally as A, in accordance with a first embodiment of the present invention. The mirror assembly includes a mirror holder 10 and a cover 11, which combined together form an integral housing 1. In the embodiment depicted, the holder 10 and the cover 11 of the housing are held together by screws or other suitable fasteners.

A mirror pane 2 is adhesively attached to a mirror carrier plate 21 rotatably affixed to an adjustment member 3. The mirror pane 2 is respectively shown in a reference position, in regard to which, it can be rotated relative to the housing. For this purpose, the adjustment member 3 is equipped with a ball joint 3a restrained against free movement, so that the mirror pane 2, in combination with the mirror carrier plate 21 is rotatable relative to the housing upon pressure against a surface thereof and restrained in place otherwise. In an alternate embodiment, the adjustment member 3 may include an electric motor controllable from the inside of the vehicle for rotating of the mirror pane 2 in relation to the housing 1.

In a first reference position, shown in FIG. 2 as a plan view cross-section, adjustment member 3 is fixed by a first connection illustrated as a recess 12 formed in mirror holder 10 and affixed thereto by screws 15. The contact surfaces joining the adjustment member 3, the holder 10 and first recess 12 are designed so that mirror pane 2 makes a first angle α with the direction of travel F when the housing is mounted to the vehicle (not shown). Mirror pane 2 is fixed in the first reference position by adjustment member 3 (prior to rotating mirror pane 2 for fine adjustment). In FIG. 2, for the purpose of clarity, the complementary angle α′=90°−α of the mirror is shown instead of first angle α.

If one turns adjustment member 3 as shown in FIG. 2 mirror housing by 180° within the mirror housing and in reference to the axis of the travel direction, mirror pane 2 is fixed in a second reference position, as can best be seen in FIG. 3. FIG. 3 illustrates the second reference position, in which the adjustment member 3 is now interlocked with a second connection illustrated in the form of a recess 13 in holder 10, and affixed to holder 10 by screws 15. The contacting surfaces of adjustment member 3, holder 10, and second recess 13 are designed so that mirror pane 2 makes a second angle β with the direction of travel F when the housing is mounted to the vehicle (not shown) and mirror pane 2 is held by adjustment member 3 in the second reference position. FIG. 3, for the sake of clarity shows a complementary angle β′=90−β to the mirror's optical axis instead of the second angle β.

In an overall examination of the Figures, it becomes clear that by affixing adjustment member 3 in housing 1 in the first reference position (FIG. 2), a driver side mirror is provided. The driver mirror has a large first angle α between mirror pane 2 and the direction of travel F. By means of affixing adjustment member 3 in the second reference position (FIG. 3) adjustment member 3, a passenger side mirror is provided with a small, second angle β. In this way, a uniform housing 1, using a uniform adjustment member 3, provides interchangeable, reversible first and second reference positions for the driver and passenger mirrors, respectively.

The two reference positions can be realized in various versions. Besides recesses 12, 13 of the illustrated embodiment, alternately correspondingly inclined contact surfaces of the housing 1 and/or of the adjustment member 3 can be designed. In similar manner, analogous to the shown embodiment, the adjustment member 3 can carry appropriate recesses, which in turn, and in accord with the reference position, accept complementary parts of housing 1.

The embodiment described here, with a first and a second recess in housing 1, enables a very compact and stable incorporation of the adjustment member 3. Adjustment member 3 may be designed with only one connection, this being, for instance, a flat contact surface and borings for screws.

In another embodiment of the present invention the adjustment member 3 may have a third or additional reference positions in housing 1. In this manner, various reference positions of the mirror pane relative to the housing, for both the driver and passenger mirrors can be realized. Housing 1 may be affixed on the vehicle at various angles relative to the direction of travel and by means of the corresponding reference position, assure the same reference position of the mirror pane. In this way, for example, various support arms and/or fastening positions on the vehicle are provided with the same exterior mirror.

In the following, various mounting positions are discussed, which differ among themselves in respect to the angle of the mirror pane against the direction of travel in a plane perpendicular to that of the exterior mirror. That is to say, the mirror is rotated within this angle. This enables placement of driver and passenger mirrors. Additionally, or alternatively, it is possible that the mounting positions, however, also present different angles of the mirror pane to the direction of travel in a vertical plane of the exterior mirror.

In a corresponding additional embodiment, FIGS. 2, 3 illustrate an mirror in a longitudinal cross-section, that is, the profile view is from the right. If adjustment member 3, as shown in FIG. 2, is placed in the first reference position, then the exterior mirror can be affixed on the vehicle at approximately the eye level of the of the driver. If, conversely, the adjustment member, as shown in FIG. 3, is placed in the second reference position, then the exterior mirror can be affixed to the vehicle at a somewhat higher level. On this account, it is advantageous to mount a driver or a passenger mirror higher or lower on the vehicle.

Similarly, the illustrated embodiment permits placing the same exterior mirror nearer or further away, in order, for example, to adapt the angle of view to accommodate the use of a trailer.

The above named placements (nearer/farther to the vehicle; higher/lower of left/right) can also, be realized by means of one, uniform, exterior mirror, whereby this has available, for each placement, a corresponding reference position for the adjustment member in the housing.

While a preferred embodiment of the invention has been described using specific terms, such description is for illustrative purposes only, and it is to be understood that changes and variations may be made without departing from the spirit or scope of the following claims.

What is claimed is:

1. An external vehicle mirror assembly which may be adjusted for use as a driver side or a passenger side rear view mirror comprising:
a mirror housing for mounting to an exterior of the vehicle;
an adjustment member adjustably affixed to said housing;
a mirror pane carried by said adjustment member;
an adjustment member affixing said mirror pane to said housing;
said adjustment member having first and second interchangeable reference positions relative to said housing, and said mirror pane being rotatably adjustable relative to said housing in either of said reference positions;
said first reference position corresponding to a driver side mirror; and
said second reference position corresponding to a passenger side mirror.

2. The mirror of claim 1 wherein said mirror pane makes a first angle (α) with the direction of travel fixed in said first reference position, said mirror pane makes a second angle (β) with the direction of travel fixed in said second reference position, and first angle is greater than said second angle.

3. The mirror of claim 1 wherein said housing comprises an integral cover and mirror holder adapted for mounting to the vehicle by a support arm, said adjustment member being affixed to said mirror holder, and said holder being affixed to said cover.

4. The mirror of claim 3 wherein said housing cover and said mirror holder are releasably attached together.

5. The mirror of claim 1 wherein said mirror pane is secured to a mirror carrier plate and said carrier plate is secured to said adjustment member.

6. The mirror of claim 5 wherein said adjustment member enables a manual rotation of said mirror pane relative to said reference position.

7. The mirror of claim 6 wherein said adjustment member enables a motorized rotation of said mirror pane relative to said reference position.

8. The mirror of claim 1 wherein said housing includes an integral housing cover and a mirror holder, and said mirror pane being secured to said mirror holder.

9. The mirror of claim 8 including first and second connections for affixing said adjustment member to said mirror holder in said first and second reference positions.

10. The mirror of claim 8 wherein said adjustment member is affixed in the first and second reference position to said mirror holder.

11. The mirror of claim 8 including an interlock connection between said adjustment member and said mirror holder having a first connection for affixing said mirror pane in said first reference position and a second connection for affixing said mirror pane in said second reference position.

12. The mirror of claim 11 wherein said first and second connections include first and second recesses for accepting said adjustment member in said first and second reference position.

13. The mirror of claim 9 including removable fasteners for affixing said adjustment member to said housing in the first and second reference positions.

14. An external vehicle mirror assembly including a mirror housing and a mirror pane carried by the housing; said housing including an adjustment member to which said mirror pane is secured, and said adjustment member affixing said mirror pane in a first reference position as a driver side mirror and affixes said mirror pane in a second reference position as a passenger side mirror.

15. The housing of claim 14 wherein said adjustment member is directly affixed to said housing in said first and second reference positions.
